(19) United States
(12) Patent Application Publication
(10) Pub. No.: US 2002/0091680 A1
(43) Pub. Date: Jul. 11, 2002

(54) Knowledge pattern integration system

(76) Inventors: Chirstos Hatzis, Cambridge, MA (US); Nandan Padukone, Melrose, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/764,724

(22) Filed: Jan. 18, 2001

Related U.S. Application Data
(60) Provisional application No. 60/242,098, filed on Oct. 20, 2000.
(60) Provisional application No. 60/228,830, filed on Aug. 28, 2000.

(51) Int. Cl. G06F 7/00

(52) U.S. Cl. 707/3

(57) ABSTRACT

The invention provides a method and relational database system to integrate knowledge patterns of different formats extracted from a plurality of different information sources. The system comprises a data analysis module, a query module, a presentation module, and an integration module.

This application claims benefit of U.S. provisional patent application, Ser. No. 60/228,830, the disclosure of which is incorporated by reference herein.

### FIELD OF THE INVENTION

This invention relates to a relational database system and more particularly the invention relates to a relational database system for extracting and integrating knowledge patterns from multi-formatted data.

### BACKGROUND OF THE INVENTION

There is an abundance of research, clinical study, clinical trial, drug interaction, drug testing, drug safety, and drug efficacy data available through both public and private channels. Finding useful information can be challenging. Once useful data are found, analysis is performed on the data and results are generated. Typically, integration of multiple forms of results is accomplished by experts with very specialized knowledge through hours of analysis. This process leads to an increase in the time and cost of bringing a new product to market. The ability to automatically recognize interdependencies among different forms of results coming from different sources of information could provide a reduction in the time and cost associated with getting a product to market or approved for market distribution.

Another issue in data analysis is the integration of new data into previous analyses. Presently, experts must reanalyze all the data previously used to generate the former results together with new data to generate new results. Thus, a previous analyses must be repeated in light of the new data. Eliminating the need to reanalyze information related to new data could lead to a reduction in the time and cost associate with getting a new product approved for commercial use.

### SUMMARY OF THE INVENTION

The invention provides methods and systems for data integration. In particular, the invention allows integration of data from different formats in a single, integrated format for presentation to a user. Methods and systems of the invention comprise a relational database for storing records in a taxonomic organization, a query-based analysis module for extracting hierarchical patterned records from the relational database, and an integration module for organizing patterned records in various user-defined formats. The invention allows coordinated access to data from multiple sources.

Integrative pattern generation according to the invention comprises obtaining query-based data from a plurality of sources, storing the data along with metadata representing the source of the information, the query, and other tools used to generate the data, and accessing the stored records for integrated presentation.

The invention is based upon a relational database design that tracks relationships between objects as they are acquired and stored. A knowledge representation scheme is encapsulated within the database that allows systems of the invention to incorporate objects and to specify their relationships according to a hierarchical scheme described in detail below. Once objects are acquired and stored, they are integrated in response to a query by an integration module. The integration module organizes and presents patterns extracted from stored data according to predetermined taxonomic rules as discussed below. A generalized architecture for a system of the invention is shown in FIG. 1.

Accordingly, in a preferred embodiment, the invention comprises a database for integrating data from multiple sources. A preferred embodiment comprises a repository capable of storing records obtained from data sources, an analysis module that receives a query and extracts query-based records from the repository, and an integration module for integrating the records into a single format for presentation. The invention may further comprise a presentation module for displaying integrated data.

Preferred embodiments of the invention incorporate further advantages, such as domain-specific dictionaries and taxonomic hierarchies appropriate for optimal data integration. Methods and systems of the invention comprise an integration module that allows integration of search results across multiple sessions without the requirement for re-analysis of the previously-integrated data. Also in a preferred embodiment, the invention provides algorithms to produce cumulative results from sequential analyses. Methods and systems of the invention allow unique pattern generation from multiple different analyses through application of pattern integration algorithms.

In a preferred embodiment, the invention provides a database comprising a data repository capable of storing records, typically obtained from an external source, an analysis module that receives a query and extracts query-based records from the repository regardless of record format, an integration module for generating an integrated information set, and a presentation module for presenting the information set.

In a preferred embodiment, the data repository stores records, either temporarily or permanently for query-based extraction. For example, the repository may be a relational database, such as a Microsoft® SQL Server 2000 database or the like. The repository may be linked to one or more servers or additional repositories from which query-based records are obtained and/or stored. Preferably, records are stored in the repository in a hierarchical manner and are cross-referred based upon interrelations between the records.

In a highly-preferred embodiment the records are health-care related records or data, such as clinical trials data, drug efficacy data, and the like. A system of the invention is capable of integrating data across multiple clinical studies in order to generate a composite of multiple data sets regardless of format, clinical data for use in a system of the invention may comprise any clinical data. Preferably, such data comprises age, gender, medication, medical history, liver status, genotype, and others relevant to the user of the system.

A data analysis module according to the invention receives a query from a user and extracts query-based records from the repository. The data analysis module is programmed to accept queries in one or more formats dictated by the programmer or by the end user. The data analysis module searches the available databases and extracts records according to pre-programmed instructions. Preferably, the data analysis module comprises a query module. However, the query module may be a separate module as described below.

An integration module of the invention orders the records obtained by the data analysis module for integrated presentation to the user. Integration may take many forms, such as those exemplified below. Preferably, however, integration is based upon hierarchical rules based upon the complexity of the records being searched and the parameters of the search request.

A detailed description of certain preferred embodiments follows.

### DESCRIPTION OF THE DRAWINGS

FIG. 1 shows a basic block diagram of the relational database system.

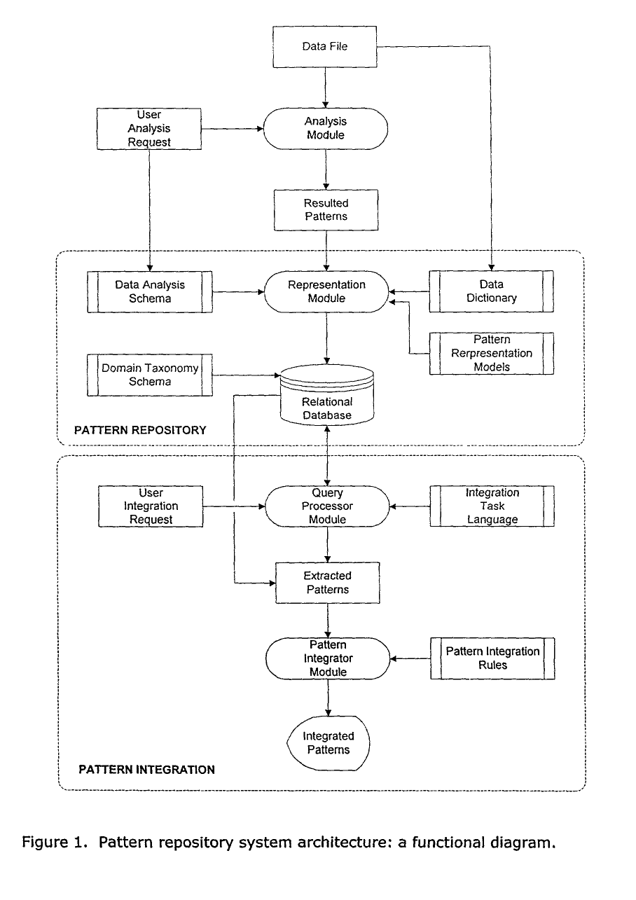

FIG. 2 shows a typical taxonomy for clinical research and drug development domains.

FIG. 3 shows a generalized database schema.

FIG. 4 shows a preferred query processor architecture.

FIG. 5 shows an exemplary algorithm of level-1 integration.

FIG. 6 is a screen shot showing an example of level-1 integration output.

FIG. 7 is a schematic of level-2 integration.

FIG. 8 is a screen shot showing an example of level-2 integration output.

### DETAILED DESCRIPTION OF THE INVENTION

Systems and methods of the invention allow retrieval, storage, and analysis of disparate data sets to produce integrated knowledge patterns. The invention allows efficient storage, retrieval, and analysis of integrated data. This, in turn, allows pattern recognition and problem solving that are not possible with non-integrated data sets.

According to the invention, data are retrieved from a plurality of sources and stored, along with related metadata (representing the source of the data, links, search and retrieval information, etc.), in a repository as records. The repository organizes records in a hierarchical fashion based upon a predetermined taxonomy. The system then accepts a query, which may be an analysis request, and extracts appropriate records from the repository according to taxonomic rules. An integration module transforms the extracted records into an integrated pattern, called a knowledge pattern, for presentation to the user. Patterns are generated according to the type of query and the algorithm used. For example, statistical characterization algorithms may produce tabular representations as data tables, cross-tabulation matrices, or 2-D plots. Thus, the invention transforms disparate, but related data sets or records into an integrated format for viewing.

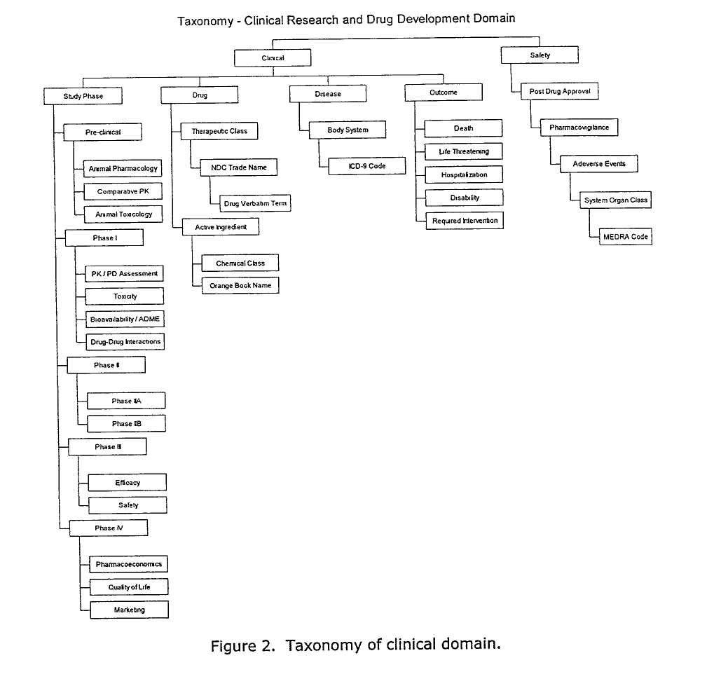

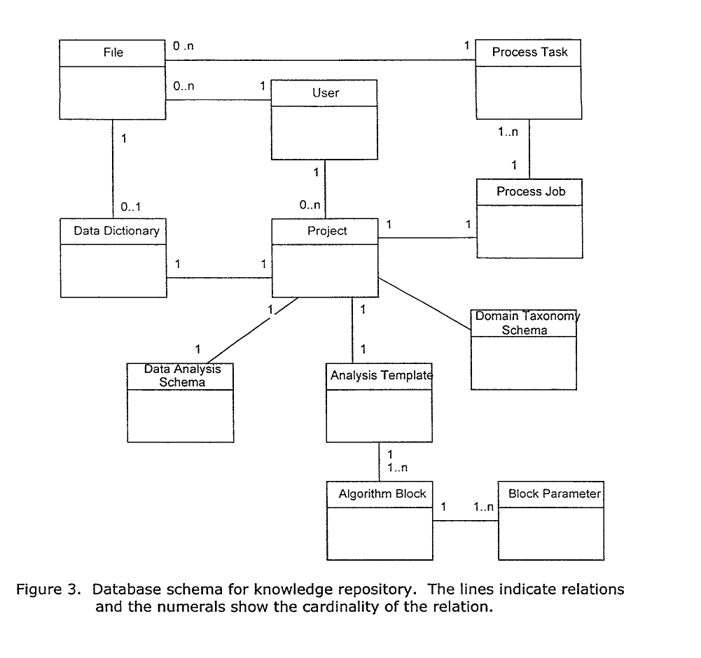

Systems of the invention comprise three primary elements. The first is a data repository which stores, organizes, and maintains data and metadata as discrete records. A basic scheme for the knowledge repository is shown in FIG. 3. Records are stored in the data repository according to schema that facilitate retrieval and integration of records containing similar data in response to a query. At the broadest level, records are grouped into taxonomies or domains which include broad categories upon which data are organized. An example of domain-level organization for clinical data is shown in FIG. 2. Top-level organization comprises categories, such as “clinical” and “safety”. Each domain has a particular taxonomic organization which specifies aspects of each top-level category, such as “study phase”, “drug”, and “outcome”. Each of these taxonomic groupings allows storage of data in a manner that facilitates query-based retrieval of like groups. A second layer of organization captures structural and functional relationships between retrieved records. For example, metadata, such as the source of a record, definitions of fields, outliers, parameters for analysis, and others. Finally, representations of the models used for analyzing and grouping records are recorded. For example, a decision tree representation captures the binary structure of the analysis, the value of the conditional variable (“if” part of the rule) and the predicted variables (“then” part of the rule). These three layers of organization, together with session information comprise the “knowledge representation” of a typical system of the invention.

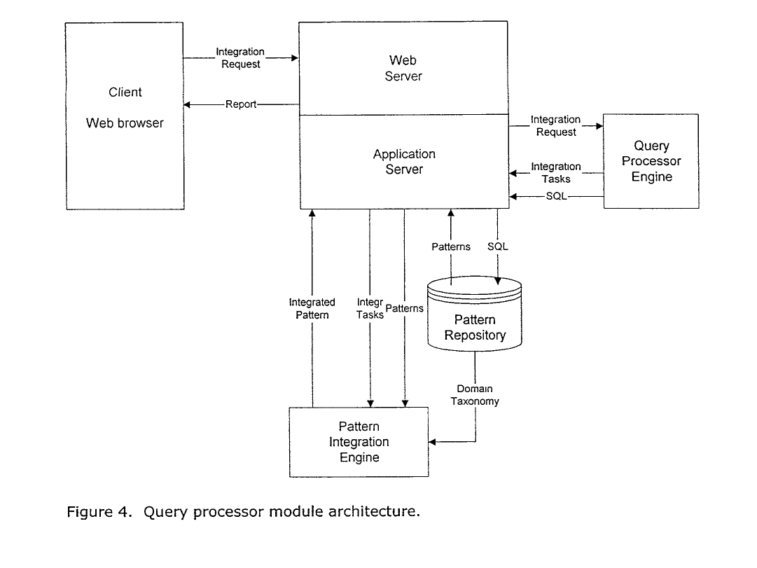

A second component of the system is a query module. The basic function of the query module is to search through the records stored in the repository and to retrieve appropriate records in response to a query. The basic architecture of the query module is shown in FIG. 4. In a preferred embodiment of the invention, a specific task description language is implemented to define top level query instruction. The specific terms of the task description language provide information regarding which records are to be retrieved and whether or not pattern integration is to be attempted on the retrieved records. The main construct of the task description language is a logical task request, which is defined in terms of an operator, project specification, query specification predicates, and other constraints on factors, outcomes, or context of the derived knowledge patterns. For example, logical tasks have the following general syntax in which square brackets indicate optional predicates, and vertical bars indicate exclusive-or of possible predicates. Due to the complexity of the syntax, the clauses are defined in separate statements following the general syntax.

OPERATOR select_list

[FROM source_project]

[WHERE search_condition]

[REPRESENTED AS representation_condition]

The syntax of the operators provided to support pattern retrieval and integration tasks is shown below. An explanation and details of use of the various operators is given in Table 1.

TABLE 1
OPERATOR statement ::=
{

EXPLORE
| EXPLAIN [ ABSENCE OF ]
| EXTRACT [ GROUPS HAVING < search_condition > ]
| CHARACTERIZE EFFECT OF < select_list > ON
| COMPARE < select_list > [ ACROSS ( < time_condition > ) ]
| CONTRAST < select_list > { INCREMENTAL
[ ACROSS < time_condition > ]
| DEVIATION FROM { AVG | MIN | MAX } }

}

Operators supported in task description language.

| Operator | Modifier | Function | Explanation |
|---|---|---|---|
| EXPLORE | <None> | Retrieval | Retrieves knowledge |
| | | | patterns that match |
| | | | specified criteria |
| EXPLAIN | <None> | Integration | Provides an integrated |
| | | | view of factors that explain |
| | | | occurrence of knowledge |
| | | | patterns matching specified |
| | | | criteria |
| EXPLAIN | ABSENCE OF | Integration | Provides an integrated |
| | | | view of factors that explain |
| | | | absence of knowledge |
| | | | patterns matching specified |
| | | | criteria |
| EXTRACT | <None> | Integration | Same as EXPLAIN, except |
| | | | that only the appropriate |
| | | | factors are extracted and |
| | | | presented in integrated |
| | | | view |
| EXTRACT | GROUPS | Integration | Extracts subgroups from |
| | HAVING | | appropriate knowledge |
| | | | pattern representations |
| | | | (e.g. cluster table) that |
| | | | match specified criteria |
| CHARAC- | EFFECT OF . . . | Integration | Produces a composite view |
| TERIZE | ON | | of the effects of a given |
| | | | variable on an outcome |
| COMPARE | <None> | Integration | Compares knowledge |
| | | | patterns matching specified |
| | | | criteria |
| COMPARE | ACROSS | Integration | Compares knowledge |
| | | | patterns across datasets |
| | | | related along a dimension |
| | | | (e.g. time) |
| CONTRAST | INCREMENTAL | Integration | Produces new knowledge |
| | | | patterns highlighting |
| | | | incremental differences |
| | | | across a specified |
| | | | dimension |
| CONTRAST | DEVIATION | Integration | Compares differences |
| | FROM | | between specified |
| | | | knowledge patterns and |
| | | | their specified aggregate |
| | | | property |

The syntax of the operator arguments for specification of the query tasks and search condition predicates is given below.

<select_list>::=

{
({attribute_name | class_name | expression }
[{AND | OR }{attribute_name | class_name | expression }])

}[,...n]

The Select list specifies the combination of outcomes or knowledge patterns that are specified for retrieval or integration across data sets. Requests are defined in terms of attribute names, e.g. disease or drug name, for specific queries or in terms of class names or terms lower in the domain hierarchy for more general queries. The main construct can be repeated several times.

<source_project>::=

{
[{database_name | user_name | company_name }.]project_name
}[,...n]

The query can be targeted to specific projects in the database or can be executed against all available knowledge. Specifying a database, a user or a company name, restricts the scope of the query.

<search_condition>::=

{
<predicate> | (<search_condition>)

[{AND | OR }{<predicate> | (<search_condition>)}]

}[,...n]

<predicate>::=

{ expression {=|<>|!=|<|>|<=|>=} expression }

Search conditions are specified in terms of predicates (expression that calculate to TRUE or FALSE). An expression can be an attribute name, class name, metadata name, string, or constant.

<representation_condition>::=

{ MODEL|TABLE|PLOT }[,...n]

The representation conditional allows the user to limit the search and retrieval to knowledge patterns of a specified representation, such as models, tables or plots. Additional conditions on the context of the representation can be specified through the more general search condition described above.

<time_condition>::=

{
{DAY | WEEK | MONTH | QUARTER | YEAR }
[BETWEEN expression AND] expression
}

Finally, the above construct allows the specification of a time interval in days, weeks, months, quarters or years across which the knowledge patterns can be compared.

Examples of Using the Task Description Language to Initiate a Query

The following examples demonstrate how the task description language is used to specify extraction or integration tasks. Examples are drawn from the clinical domain, but application of the above system is not restricted to any specific domain.

For example, the query “EXPLORE Lipodistrophy” Retrieves all records containing knowledge patterns related to the attribute lipodistrophy. Since additional constraints were not specified, all records having knowledge patterns containing lipodistrophy will be retrieved. The entire data repository will be searched since a dataset was not specified.

The query “EXPLAIN ABSENCE OF Jaundice AND Fever FROM (Safety_I_{—}99, Safety_II_{—}99)” Retrieves all records containing knowledge patterns from the specified datasets (Safety_I_{—}99 and Safety_II_{—}99) that can explain the lack of joint occurrence of side effects jaundice and fever. In addition to displaying the individual knowledge patterns that were retrieved by the query, the system also integrates the retrieved knowledge patterns and displays a composite knowledge pattern explaining the absence of the joint event.

The query “EXPLAIN Lipodistrophy OR Pancreatitis FROM Domain.AERS_{—}99 WHERE (Drug_PT=Stavudine)” Retrieves all records containing knowledge patterns derived from dataset AERS_{—}99 in database Domain that explain the adverse events lipodistrophy or pancreatitis for the antiretroviral drug Stavudine.

The query “CHARACTERIZE EFFECT OF Adverse_Events ON Prescription FROM Marketing_Set” Retrieves all records containing knowledge patterns that were derived from dataset Marketing_Set and contain both attributes Adverse_Events and Prescription. Then the system produces a composite profile to characterize Prescription by extracting only those knowledge patterns containing the attribute Adverse_Events.

The query “EXTRACT GROUPS HAVING (Prescription=HIGH) WHERE (Algorithm=‘k-means’)” Retrieves all records containing knowledge patterns having grouping representations (e.g. cluster tables, cluster plots) that also contain the attribute Prescription. Only knowledge patterns produced through the k-means clustering algorithm are selected. No data source was specified, so the entire data repository is searched. Then the system extracts those knowledge patterns that are associated with Prescription=High and integrates the knowledge patterns.

The query “COMPARE Survival_time ACROSS (YEAR BETWEEN 1990 AND 1999) FROM (Clin_I, Clin_II, Clin_III) WHERE (GENDER=F)” retrieves records created from clinical trials Clin_I, Clin_II, and Clin_III between years 1990-1999 and compare knowledge patterns for survival times among females. This query extracts the relevant records from the data repository and then, for the compatible knowledge pattern representations, it compares the knowledge patterns across time to highlight similarities and differences.

Data analysis begins when a query processor module maps the operators of the task description language to (1) standard SQL statements that can be executed against the relational database and (2) into integration operators that are executed by the pattern integration module.

The architecture to enable pattern query and integration is shown in FIG. 4. This particular example demonstrates a web-based architecture, but it could also apply to client-server or stand-alone application architectures. A user's pattern integration task is captured by the web server and passed on to the application server by activating a servlet. The servlet passes the request to the query processor engine, which returns a set of SQL statements and integration tasks. The SQL statements are executed against the pattern repository to retrieve the relevant patterns. The returned patterns and the integration instructions from the previous step are now passed on to the pattern integration engine that produces the integrated patterns using appropriate algorithms. Finally, the web server reports the integrated patterns back to the client.

To illustrate the action of the query processor module, consider the following user request described above:

EXTRACT GROUPS HAVING (Prescription=HIGH) WHERE (Algorithm=‘k-means’)

Based on this request, the query processor engine first formulates the appropriate SQL statement to retrieve the matching patterns from the repository:

SELECT object_name, object_location FROM Pattern_Repository

WHERE attribute_name=‘Prescription’

AND object_type=‘cluster table’

AND algorithm=‘k-means’

The integration module then searches each object in the retrieved collection of objects (patterns) for groups that contain the predicate prescription=high. If a group contains the above predicate, it is extracted from the original object and appended to the new object representing the integrated pattern. A pseudocode that accomplishes this task is shown below:

INTEGR_OBJECT={}
FOR EACH object IN (objects)

FOR EACH group IN (object.groups)

IF object.prescription = HIGH THEN

INTEGR_OBJECT = INTEGR_OBJECT ∪ group

NEXT group

NEXT object

Different integration requests might involve different types of patterns, which in general require specialized integration algorithms. These algorithms are described next.

In one embodiment, the system comprises a data analysis module A key function of this module is to allow a user to extract patterns from the repository that match user-specified criteria. The data analysis module captures the appropriate data from the repository to generate patterns for presentation to the user. The pattern that results from any given search is based on the user query and the analysis module itself. For example, if the user wishes to generate a decision tree to assist in assessing the efficacy of a drug, the data analysis module captures the binary-tree structure of the records related to the request, and the values of the conditional (predictor) variable (IF part of the rule) and the predicted variables (THEN part of the rule) at each node of the tree. If, however, the user wishes to generate a cluster pattern, the data analysis module captures the distributional statistics of each variable in the cluster (categorical or continuous-valued) and a measure of the size of each cluster. There are, of course, certain elements common to all patterns produced by the system that are captured by the data analysis module. Examples of such elements include, but are not limited to, statistical bias, reliability, and confidence intervals.

In addition to pattern generation, metadata are captured by the data analysis module during the information analysis process. Metadata are used to help determine the relationship between records when the query module searches the data repository for records in response to a query request. Examples of metadata include, but are not limited to, the origin of records, the type of analysis the data analysis module was asked to perform, the algorithm used to extract the pattern, the values or ranges of certain parameters of the algorithm, and the date, time, and session name. Typically numerous other pieces of metadata are generated by the data analysis module when the information is being analyzed to extract a knowledge pattern. The data analysis module provides records containing the metadata and knowledge patterns to the data repository for storage and retrieval by the query module. Retrieved patterns can be statistically based or exploratory based depending on the algorithm chosen to perform the analysis. In one embodiment, if the user chooses to generate a statistical-based knowledge pattern, the data analysis module generates data tables, cross-tabulation matrices or two-dimensional plots. If the user chooses to perform exploratory analysis on the information the resulting knowledge patterns take the form of numerical data tables, textual data tables or three dimensional cluster plots.

A third component of systems of the invention is a pattern integration module, which enables knowledge integration at several levels, the most important of which are:

(1) Organization and presentation of patterns according to domain taxonomy

(2) Collection and integrated presentation of sub-elements of patterns

(3) Contrasting and comparing of pattern differences between related patterns.

What follows is a description of how integration tasks at the above three levels are realized in the pattern integration module.

Organization and Presentation of Related Patterns

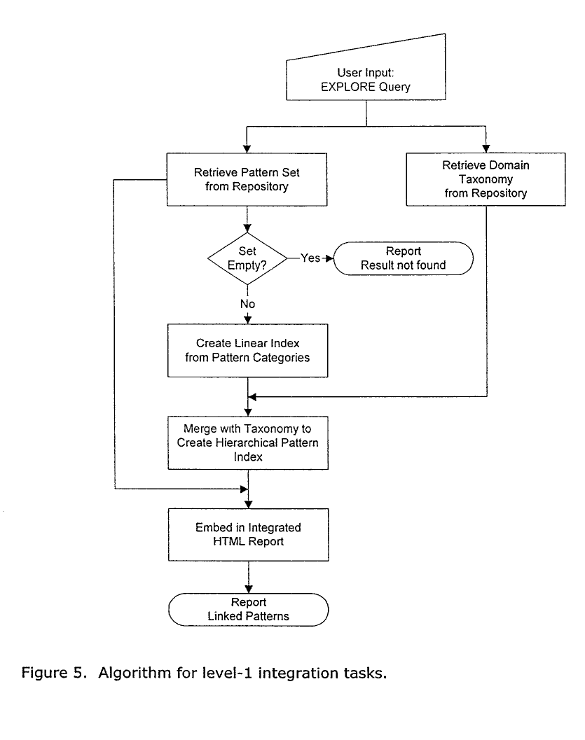

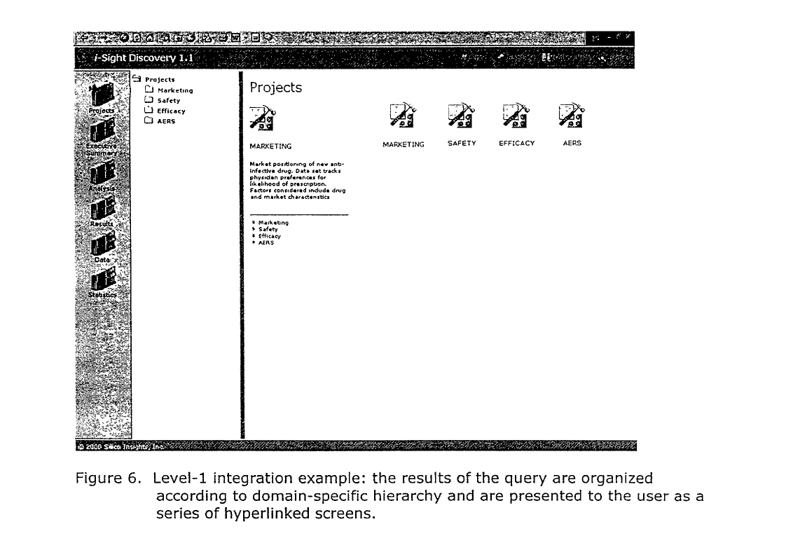

At the first level, the integration module organizes the retrieved patterns in a single hierarchy, which is consistent with the domain taxonomy. The result is a collection of hyperlinked documents organized according to an index of topics that is generated by the module. The algorithm that accomplishes the first-level integration task is shown in FIG. 5. For a description of a use case and example output see Example 2 below and FIG. 6.

Integration of Sub-Elements of Patterns

To enable the last two levels of integration, different pattern representations typically require different integration algorithms. Some patterns might not be compatible for integration with others. The integration module determines what types of patterns can be integrated based on heuristics and integration rules. For example, a Bayes classifier representation is a probabilistic one and cannot be integrated with a cluster summary table, which is based on a descriptive statistics representation. Whenever possible, the integration module converts the various patterns to a common rule-based representation prior to integration.

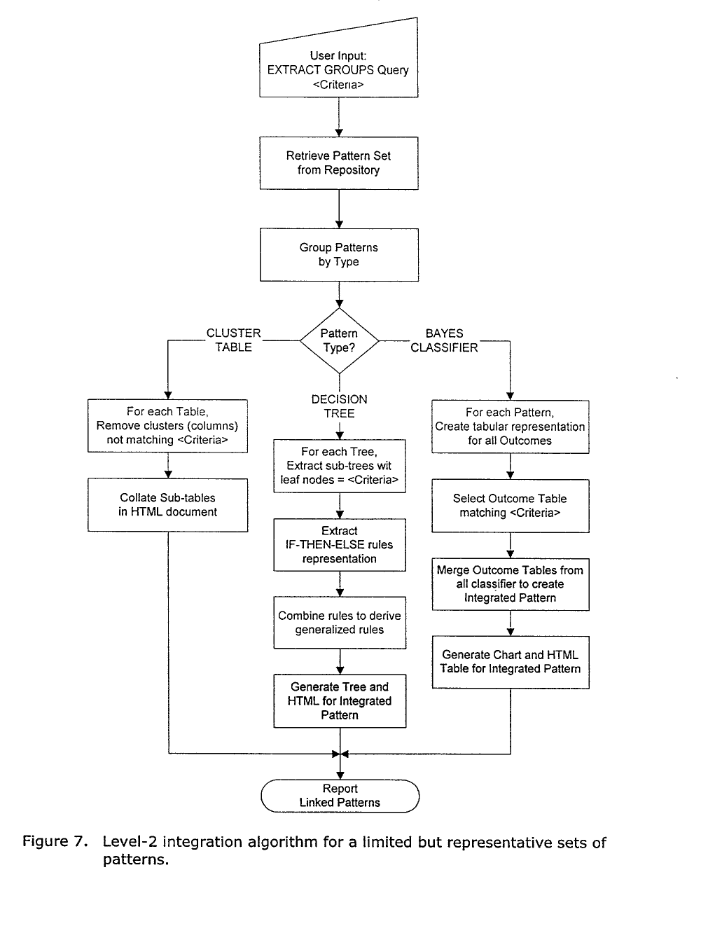

FIG. 7 shows an algorithm that implements level-2 integration of patterns. The algorithm first sort and groups the patterns retrieved from the repository according to the type or class of the pattern. Classes of patterns include but are not limited to cluster table, cluster plot, evidence or Bayes classifier, decision table, decision tree, if-then-else rules, association rules, neural networks, regression models. A different integration algorithm is applied to each type of pattern.

A cluster table is a tabular representation of clustering results. Each column of the table represents a distinct cluster or group of observations that are determined by the algorithm to be similar based on a pre-defined similarity metric. The rows show the average level of continuous-valued factors or the distribution of nominal factors for each cluster. For each cluster, rows that represent factor values that differ significantly from population levels are highlighted to assist visual inspection and interpretation of the pattern. The integration algorithms for cluster tables first scans the table to find highlighted cells for which the factor level matches the user specified criteria (e.g. Age>45 or Prescription_Probability=Very_Likely). The columns that lie at the intersection of these cells represent clusters that match the specified criteria. The algorithm then eliminates the remaining columns (clusters).

Another pattern is a decision or classification tree. These models summarize in a condensed representation the combinations of factors leading to a given set of outcomes. The integration algorithm for decision trees first identifies the leaf (end) nodes leading to those outcomes that match the specified criteria. It then eliminates branches leading to the non-desired end nodes.

The resulting sub-tree graphs are then converted to their isomorphic IF-THEN-ELSE rules. The same process is repeated for all selected trees. Finally the algorithm has to reconcile and condense the set of rules to a more general set of rules that applies to the entire set of patterns. The integrated pattern can then be converted back to a tree format and displayed by the system.

Bayes or Naïve classifiers are probabilistic models that summarize evidence for predicting the different values of a given outcome variable. The integration algorithm first converts the pattern to a tabular representation. The tabular representation consists of a table of conditional probabilities for each value of the outcome variable. The algorithm then selects the table(s) that matches the specified criteria. The process is repeated for all evidence classifier patterns. Finally merging all extracted sub-tables creates the integrated table. This integration procedure is legitimate due to the conditional independence property of the Naïve Bayes classifier.

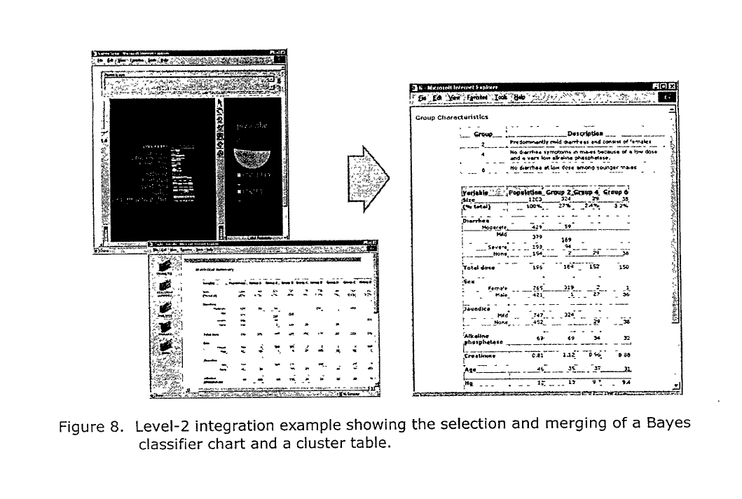

An example of the results of level-2 integration between a naive classifier and a cluster table is shown in FIG. 8.

Contrasting or Comparing of Related Patterns

Incremental algorithms and algorithms for deviation analysis allow contrasting and comparing similar patterns or patterns that have been converted to the common rule-based representation.

As an example consider a scenario where new data on the safety of a drug is collected on a daily basis and an analysis is run each day to determine the underlying patterns. Changes in these patterns could represent early signs of serious adverse events.

Given two Bayes classifier patterns that represent patterns from consecutive days, the algorithm first looks for changes in the relative order of factors within the pattern. Factors at the top of the list signify stronger correlation with the outcome. Factors for which the order has changed are highlighted in a different color. In the next step, the algorithm looks closer within each factor. In this step it compares the conditional probabilities for each factor range given the value of the outcome and highlights a range that has significantly changed probabilities compared to the previous time point. The results of the comparison are also presented in tabular form in FIG. 8.

### I. EXAMPLES

Pattern Query and Integration The following are three examples of ways in which the system described above might be used in practice, followed by a more general example.

### Example 1

A typical scenario in clinical drug development is to integrate results for a particular drug across the phases of clinical development. The data are usually organized by study in databases or datasets. Data from each phase are analyzed separately to produce statistical data summaries, plots, or other statistical model representations (e.g., random mixed effect models). The resulting files are saved in the file system of a server. Users wanting to find a composite efficacy or safety profile for the drug need to find where the files are stored in the company's central file server, retrieve those files, and organize the results in a logical way (e.g. by clinical phase).

This task is simplified considerably by a pattern integration system of the invention. Systems of the invention keep track of all files produced by a number of analyses, automatically annotating each file with the appropriate metadata. To execute a query, the user selects his or her database and the desired drug from the list of candidate drugs. Under the Exploratory category the user selects Explore. The system will execute an EXPLORE task for the particular drug and collect the resulting patterns. Using the taxonomic representation of the clinical domain stored in the repository, the system then organizes the results into groups according to the clinical phase and efficacy or safety objectives. The user will receive a hyperlinked table with navigational links to explore the results of the exploratory request (see FIG. 6).

### Example 2

An application that is enabled through the use of systems of the invention is the incremental updating of patterns. The pattern repository stores the cumulative knowledge obtained from a user's research effort. As such, the repository grows in size and complexity with time as more patterns are deposited.

An application that is often of interest in the clinical and post-drug approval phases is incremental updating of knowledge as more information becomes available. Instead of having to reanalyze all data cumulatively, the data are analyzed incrementally and the cumulative patterns are updated accordingly. This type of analysis is not supported by standard statistical or data mining systems. The disclosed system can carry out incremental, comparative analysis along a dimension (e.g. time) for data of similar structure.

The user under Comparative analysis selects the incremental contrast method, the database of interest, and the time window. The system executes a CONTRAST INCREMENTAL task and reports the results in a series of contrast plots. Finally, an integration algorithm is executed to update the cumulative pattern using the most recent incremental pattern. The user can also run this analysis in DEVIATION mode, to highlight differences from the average profile, or from an expected, pre-set pattern.

### Example 3

In this scenario, a drug has been on the market for a year. The Director of Medical Affairs would like to monitor and track adverse reactions caused by the drug. For this purpose the company maintains a post-drug approval database and it licenses prescription data from a Health Services company. Also, there is a public domain database maintained by the FDA to keep track of all reported adverse events on drugs that are on the market. Assume that the drug of interest is the antiretroviral drug Stavudine and the adverse reaction of interest is a condition called lipodystrophy, which is caused by the use of antiretroviral drugs in AIDS patients.

To collect the necessary data, the user will have to execute queries against the three available databases and then merge and analyze the extracted records to discern possible patterns among the tracked variables that could help explain the incidents. The difficulty in this case is to ensure uniformity in the formats of the different databases.

To expedite the data analysis and decision making process, an automated pattern discovery template is set up for unsupervised execution against the available databases in regular intervals. The results from these analyses are annotated and stored in the pattern repository. The user then executes integration query requests against all available patterns that have resulted from the analyses. Under the Explanatory category of the user interface, the user selects one or more of the available databases, the drug to be tracked (Stavudine), and the desired adverse event (lipodystrophy). The system then translates the request to an EXPLAIN task that is executed against the databases. Additional constraints can be specified through the user interface. To enable integration of patterns across databases that could have different formats and naming conventions, the repository uses domain specific dictionaries that define the appropriate mappings between terms or attribute names.

The results of an explanatory task are presented at two different levels: as a hyperlinked table (as in Case 1), or as information in integrated tables showing the differences and common trends among the factors causing lipodystrophy across the various datasets.

The invention has been described in terms of its preferred embodiments. Alternative embodiments are apparent to the skilled artisan upon examination of the specification and claims.

What is claimed is:

1. A relational database system for analyzing and integrating knowledge patterns extracted from data sets, the system comprising:
a data repository configured to store data from a plurality of sources in a plurality of formats;
a data analysis module capable of receiving a query and extracting query-based records from said data repository regardless of format;
an integration module configured to integrate said query-based records to generate a single-format integrated information set; and
a presentation module for presenting said single-format integrated information set.

2. The system of claim 1, wherein said system is based in a domain specific XML language.

3. The system of claim 1, wherein said integration module is configured to generate said information set based upon interdependencies of said query-based records.

4. The system of claim 1, wherein said integrated information set is stored in a memory.

5. The system of claim 1, wherein said data comprises clinical drug trials data.

6. The system of claim 1, wherein said integration module extracts patterns from said query-based records.

7. The system of claim 5, wherein said integrated information set comprises drug safety data.

8. The system of claim 5, wherein said integrated information set comprises drug efficacy data.

9. The system of claim 1, wherein said single-format integrated information set comprises data integrated from multiple clinical studies.

10. The system of claim 9, wherein said integrated information set comprises data from multiple clinical trials of the same drug candidate.

11. The system of claim 1, wherein sad query combines a plurality of clinical attributes.

12. The system of claim 11, wherein said attributes are selected from the group consisting of age, gender, medication, diseases status, genotype, and medical history.

13. A method for presenting data integrated from multiple data sets, the method comprising the steps of:
storing data from a plurality of sources in a plurality of formats;
extracting at least a portion of said data in response to a query;
integrating said data into a single-format information set; and
displaying said information set.

14. The method of claim 13, wherein said extracting step comprises retrieving data based upon interdependencies of said data in relation to a query.
